(19) United States
(12) Patent Application Publication
(10) Pub. No.: US 2005/0217593 A1
(43) Pub. Date: Oct. 6, 2005

(54) Covered animal feeder with mounting brackets

(76) Inventor: Andrew D. Rice, Sumiton, AL (US)

Correspondence Address: Richard C. Litman;LITMAN LAW OFFICES, LTD., P.O. Box 15035, Arlington, VA, 22215, US

(21) Appl. No.: 10/816,918

(22) Filed: Apr. 5, 2004

(51) Int. Cl. A01K 1/10; A01K 5/00

(52) U.S. Cl. 119/60

(57) ABSTRACT

The covered animal feeder with mounting brackets is a container configured to distribute animal feed to livestock. It has an open top, a bottom, a back wall, two sidewalls and a front wall with openings through which an animal can pull hay. The feeder also has a hinged cover to protect feed within the container from moisture and has mounting brackets extending from the back wall that allow the container to be mounted to the top rail of a standard livestock fence. The hinged cover includes two sets of hinges, which allow the cover to be opened from either the front or back of the container thereby allowing a person to load the container from the opposite side of the fence on which the container is mounted and avoid entering the area enclosed by the fence.

### BACKGROUND OF THE INVENTION

1. Field of the Invention

The present invention relates to animal feeders, and more particularly to a covered animal feeder with mounting brackets that mounts to a standard livestock fence and includes a hinged cover to protect animal feed contained therein from rain and snow, thereby avoiding unnecessary waste of animal feed.

2. Description of the Related Art

Conventional animal feeders are used to feed livestock, such as horses, cows and goats, and typically consist of open-topped bins from which animals withdraw feed. Unfortunately, a number of problems are associated with these feeders. First, and most notable, conventional animal feeders do not protect the feed contained therein from moisture. Hence, because conventional feeders include open tops, the feed contained therein becomes wet during periods of rain or snow and, once wet, often spoils and is wasted. This is especially problematic with alfalfa hay, a sweet tasting high-protein hay that is relatively expensive and that quickly becomes sour when wet.

Another problem associated with conventional feeders is that the feeders are not sized to receive an entire bale of hay. Therefore, time and energy must be taken to break up the bale of hay before loading it into the feeder and, further, the feeder must be loaded more often.

Additionally, conventional feeders are not accessible from outside an animal's pen, and therefore a person must enter the pen to load them. However, there are many occasions where it may not be safe or appropriate to enter an animal's pen.

Furthermore, conventional feeders cannot effectively be used to combine two types of feed, such as, for example, hay and grain. When the two are combined in one feeder, an animal typically must eat all of one type of feed to get to the other.

Examples of prior art animal feeders are provided by U.S. Pat. No. 23,386, issued Mar. 29, 1859 to J. Packer (feed rack); U.S. Pat. No. 3,362,382, issued Jan. 9, 1968 to M. O. Frasier (portable feeder); U.S. Pat. No. 3,853,096, issued Dec. 10, 1974 to A. J. Whitty (small animal feeder); U.S. Pat. No. 4,976,222, issued Dec. 12, 1990 to J. V. Cooke (horse feeder); U.S. Pat. No. 5,000,122, issued Mar. 19, 1991 to A. L. Smith (horse feeder); U.S. Pat. No. 5,694,885, issued Dec. 9, 1997 to E. A. Deitrich et al. (animal feeder with perch assembly); U.S. patent Publication No. 2003/0033987, published Feb. 20, 2003; U.S. Pat. No. 6,606,962, issued Aug. 19, 2003 to R. Elliot (horse feeder); and U.S. Design Pat. No. 392,777, issued Mar. 24, 1998 to R. L. Scribner.

Accordingly, none of the above inventions and patents, taken either singly or in combination, is seen to describe the instant invention as claimed. Thus, a covered animal feeder with mounting brackets solving the aforementioned problems is desired.

### SUMMARY OF THE INVENTION

The covered animal feeder with mounting brackets is a container configured to distribute animal feed to livestock. It has an open top, a bottom, a back wall, two sidewalls and a front wall with openings through which an animal can pull hay. It also has a hinged cover to protect feed within the container from moisture and has mounting brackets extending from the back wall that allow the container to be mounted to the top rail of a standard livestock fence.

The hinged cover includes two sets of hinges, which allow the cover to be opened from either the front or back of the container depending on which set of hinges is used, i.e., depending on which set of hinges has hinge pins inserted therein. Thus, when mounted to a livestock fence, the container can be loaded from either the front or the back. Significantly, this allows a person to load the container from the opposite side of the fence from that on which the container is mounted and, thereby, avoid entering the area enclosed by the fence.

The container is shaped and dimensioned to receive an entire bale of hay at one time, thereby minimizing the frequency with which the container must be loaded and allowing the person loading the container to avoid the task of breaking up bales of hay.

Additionally, in an alternative embodiment, the bottom is sloped downward toward the front wall so that feed within the container will slide toward the openings in the front wall thereby providing livestock with easier access to the feed. In another alternative embodiment, a side dish is mounted to an outside surface of one of the sidewalls. With the side dish, the feeder can provide two types of feed, such as hay and grain, in an arrangement where both types can be eaten simultaneously.

Accordingly, it is a principal object of the invention to provide an animal feeder with a hinged cover that protects feed contained therein from moisture.

It is another object of the invention to provide an animal feeder with mounted brackets that allow the feeder to be easily secured to the top rail of a standard livestock fence.

It is a further object of the invention to provide an animal feeder that is shaped and dimensioned to receive an entire bale of hay.

Still another object of the invention is to provide an animal feeder that can be easily loaded from outside a fenced area.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a covered animal feeder with mounting brackets according to the present invention.

FIG. 2 is a perspective view of a covered animal feeder with mounting brackets according to the present invention.

FIG. 3 is an exploded view of the feeder shown in FIG. 2.

FIG. 4 is a top view of a covered animal feeder with mounting brackets according to the present invention.

FIG. 5A is a side view of a covered animal feeder with mounting brackets according to the present invention.

FIG. 5B is a side view of an alternative embodiment of a covered animal feeder with mounting brackets according to the present invention.

FIG. 6 is a perspective view of a second alternative embodiment of a covered animal feeder with mounting brackets according to the present invention.

FIG. 7 is a perspective view of a side dish for the second alternative embodiment of a covered animal feeder with mounting brackets according to the present invention.

Similar reference characters denote corresponding features consistently throughout the attached drawings.

### DETAILED DESCRIPTION OF THE PREFERRED EMBODIMENTS

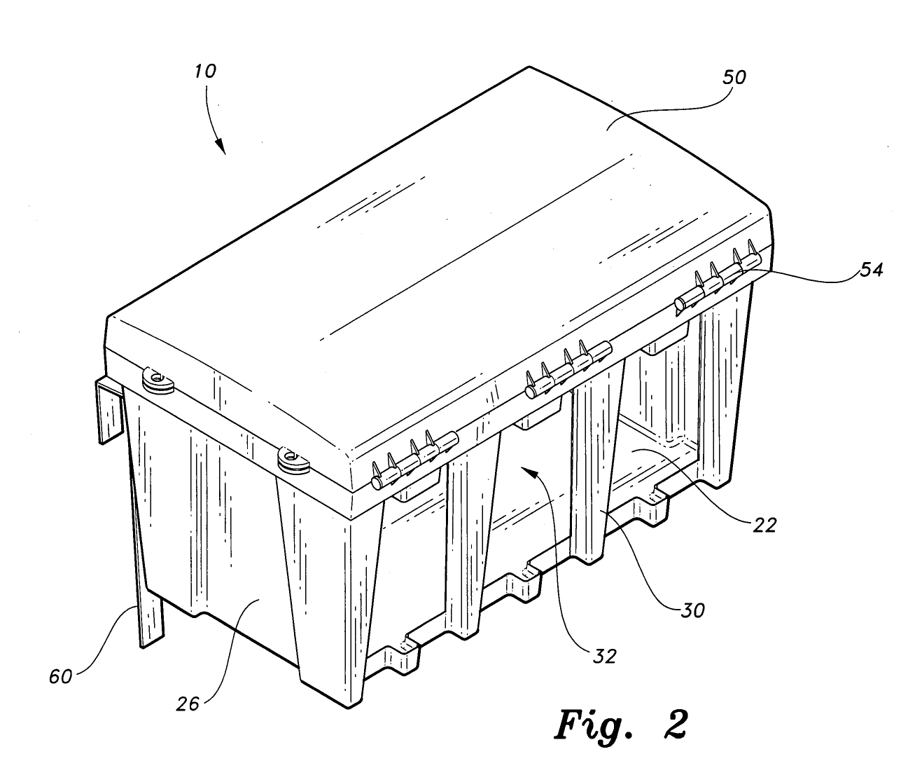

The present invention is a covered animal feeder with mounting brackets, designated generally as 10 in the drawings, that is configured to distribute animal feed to livestock. As shown in FIGS. 2 through 5A, the feeder 10 includes a box-shaped container 20 with an open top, a bottom wall 22, a back wall 24, two sidewalls 26 and 28 and a front wall 30 with openings 32 through which an animal can pull hay. It also has a hinged cover 50 to protect feed within the container 20 from moisture and has mounting brackets 60 extending from the outer surface of the back wall 24 that allow the container 20 to be mounted to the top rail of a standard livestock fence.

The container 20 has the shape of a rectangular box with ridges or ribs formed in the front 30, back 24, and sidewalls 26 and 28. The front wall 30 has three openings 32, each of which is substantially rectangular in shape with a width of about seven inches and is configured to allow a large animal easy access to the contents of the container 20.

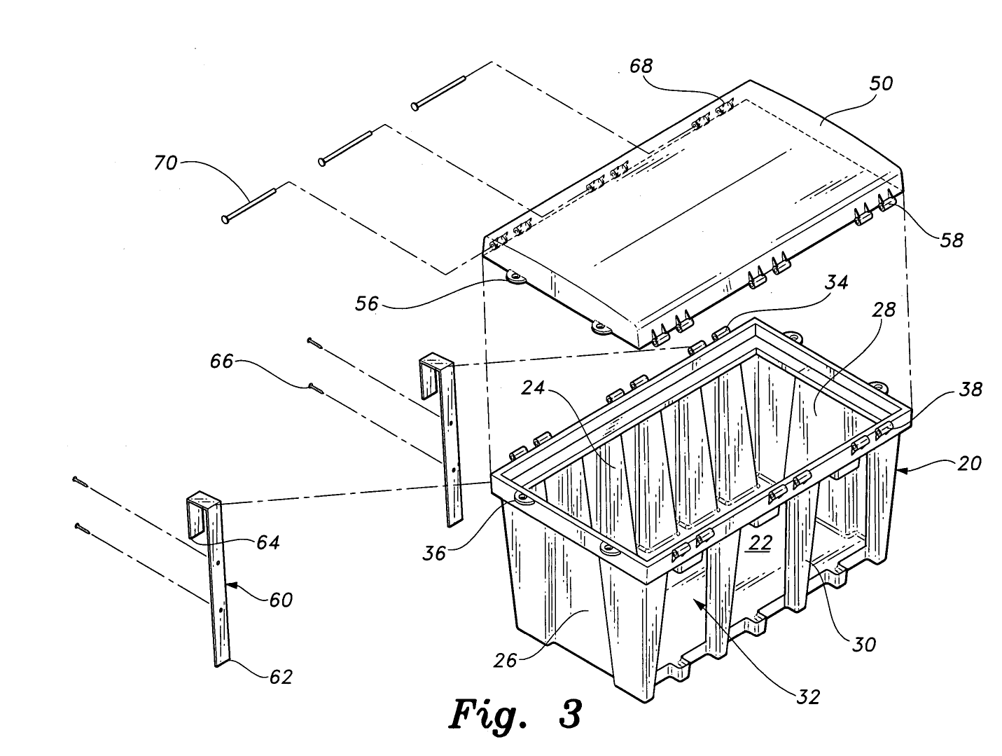

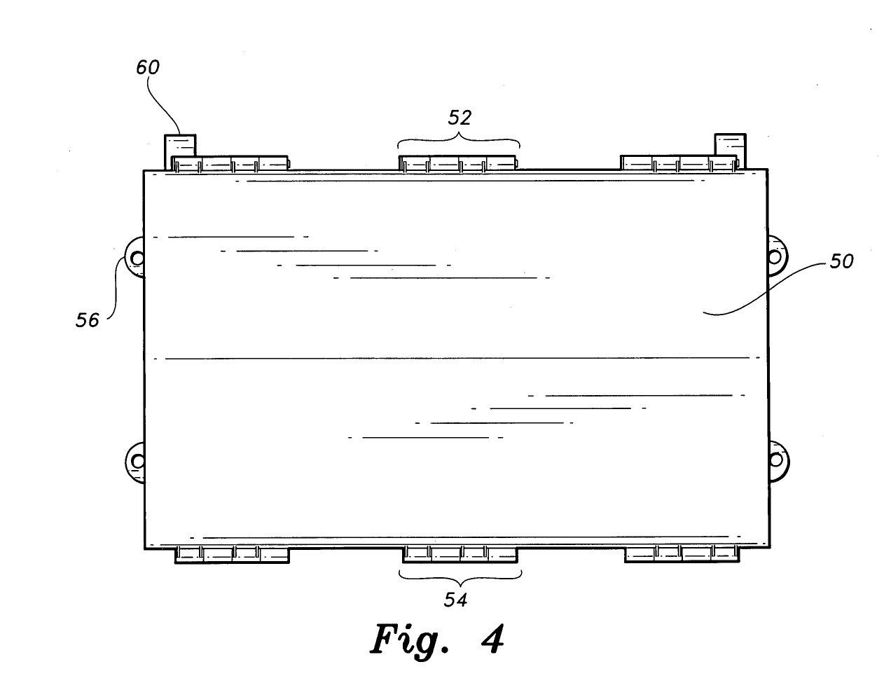

The hinged cover 50 includes two sets of hinges, a back set 52 attached to back wall 24 and a front set 54 attached to front wall 30(shown in FIG. 4), but only one set of hinge pins 70 (shown in FIG. 3). Thus, only one set of the hinges 52 and 54 is used at a time. The two sets of hinges 52 and 54 enable the cover 50 to be adjoined to either the front wall 30 or back wall 24, thereby allowing the cover 50 to be opened from either the front or back of the container 20 depending on which set of hinges 52 and 54 is used, i.e., depending on which set of hinges 52 and 54 has hinge pins 70 inserted therein. Each of the hinges 52 and 54 either includes barrel segments or knuckles 38 and 58 that are formed in the front edge of the cover 50 and the top edge of the front wall 30, or includes barrel segments or knuckles 34 and 68 that are formed in the back edge of the cover 50 and the top edge of the back wall 24.

Each of the mounting brackets 60 has an inverted “J” shape with a proximal leg 62 and a distal leg 64. The proximal leg 62 is secured to the back wall 24 of the container 20 by two screws 66 and has a length greater than the distance between the top rail and second rail of a standard livestock fence. The mounting brackets 60 are constructed of metal, such as aluminum, or of plastic.

The feeder 10 includes four sets of padlock flanges, each set having an upper flange 56 and a lower flange 36 with aligned apertures dimensioned to receive the arm member of a padlock. Each upper flange 56 extends from a side edge of the cover 50 and each lower flange 36 extends from one of the sidewalls 26 and 28. By securing a padlock to any one of the sets of padlock flanges, the cover 50 is secured to the container 20.

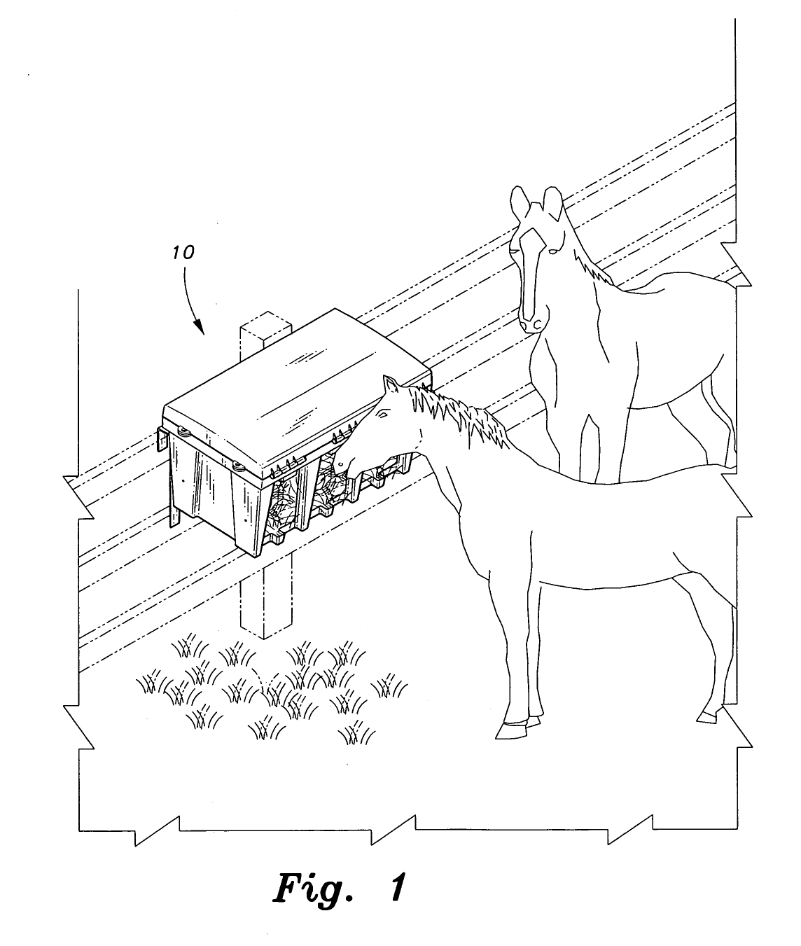

When mounted to a livestock fence, as shown in FIG. 1, the container 20 can be loaded from either the front or the back, thereby allowing a person to load the container 20 from the opposite side of the fence on which the container 20 is mounted to avoid entering the area enclosed by the fence.

The container 20 is constructed of plastic, metal or rubber and is shaped and dimensioned to receive an entire bale of hay at one time, thereby minimizing the frequency in which the container 20 must be loaded and allowing a person loading the container 20 to avoid the task of breaking up bales of hay.

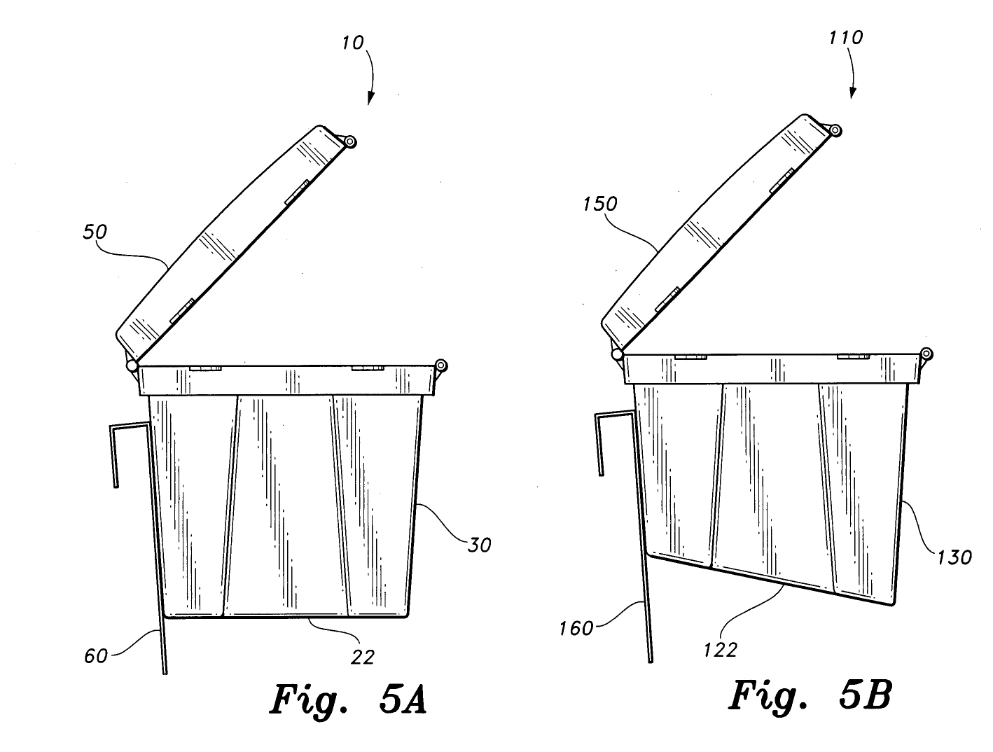

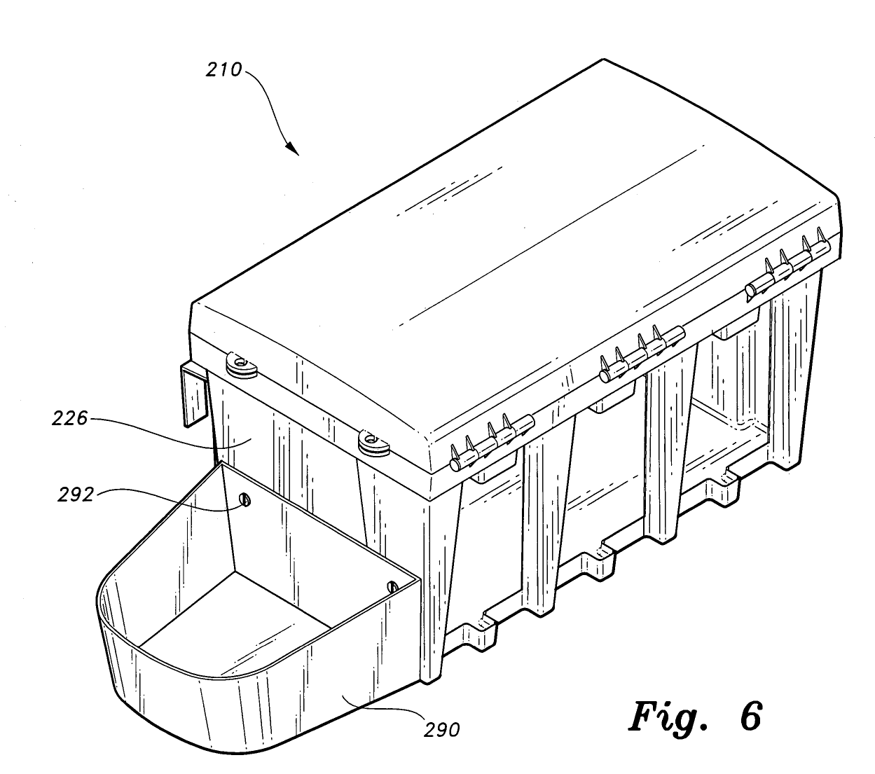

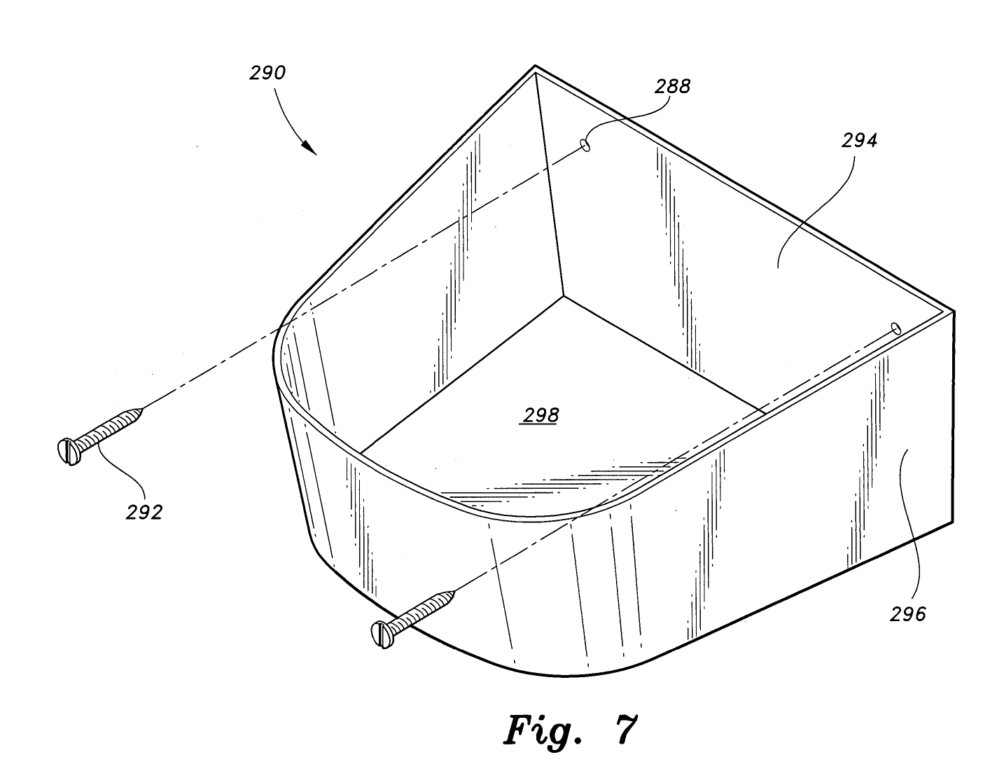

Additionally, in an alternative embodiment, the feeder 110, shown in FIG. 5B, has the bottom wall 122 sloped downward toward the front wall 130 so that feed within the container will slide toward the openings in the front wall 130, thereby providing livestock with easier access to the feed. In another alternative embodiment, the feeder 210, shown in FIGS. 6 and 7, has a side dish 290 mounted to one side 226 of the container by two screws 292. With the side dish 290, the feeder 210 can provide two types of feed, such as hay and grain, simultaneously. The side dish 290 has a bottom 298, a back wall 294 with two apertures 288, and an arcuate side wall 296.

It is to be understood that the present invention is not limited to the embodiments described above, but encompasses any and all embodiments within the scope of the following claims.

1-10. (canceled)

11. A covered animal feeder with mounting brackets, comprising:
a container having a front wall, a back wall, a bottom wall, two sidewalls joined to form a box with an open top, said front wall having at least one opening defined therein through;
whereby an animal can retrieve animal feed positioned within the container;
said container having at least one hinge knuckle extending from one of said front wall and said back wall, and adjacent to said open top;
a cover for accessing said container when is an open position, and for closing the open top of the container when in a closed position;
said cover having at least one hinge knuckle extending from an edge thereof;
at least one removable hinge pin for coupling each said at least one hinge knuckle of said container to a corresponding at least one hinge knuckle on said cover;
whereby said hinge pin and said hinge knuckles pivotally attaching said cover to said container;
at least one inverted J-shape mounting bracket secured to said back wall of said container;
each of said at least one inverted J-shape mounting bracket has a distal leg and a proximal leg opposing the distal leg, said proximal leg being attached to said back wall; and
wherein said container is adapted for mounting to a livestock fence by sliding said distal leg of said at least one inverted J-shape mounting bracket onto a top rail of the livestock fence;
whereby animal feed is loaded into said container by pivoting said cover to the open position and inserting animal feed through said open top into said container.

12. A covered animal feeder with mounting brackets, comprising:
a container having a front wall, a back wall, a bottom wall, two sidewalls joined to form a box with an open top, said front wall having at least one opening defined therein;
whereby an animal can retrieve animal feed positioned within said container;
a cover for closing said open top of said container;
a first set of opposing hinge knuckles attached to said back wall and said cover;
a second set of opposing hinge knuckles attached to said front wall and said cover; and
at least one hinge pin;
said cover is selectively attached to said container and optionally pivots on said back wall or said front wall by placement of said hinge pin through said first or second set of knuckles, respectively;
at least one mounting bracket secured to said back wall of said container;
wherein said container is adapted for removably mounting to a livestock fence by sliding said at least one removably mounting bracket onto the livestock fence; whereby animal feed can be loaded into said container by pivoting the cover to an open position and inserting animal feed through the open top into the container.

13. A covered animal feeder with mounting brackets, comprising:
a container having a front wall, a back wall, a bottom wall, two sidewalls joined to form a box with an open top, the front wall having at least one opening defined therein through which an animal can retrieve animal feed positioned within the container;
said container having at least one hinge knuckle extending from one of said front wall and said back wall, and adjacent to said open top;
a cover for accessing said container when is an open position, and for closing the open top of the container when in a closed position;
said cover having at least one hinge knuckle extending from an edge thereof;
at least one removable hinge pin for coupling each said at least one hinge knuckle of said container to a corresponding at least one hinge knuckle on said cover;
whereby said hinge pin and said hinge knuckles pivotally attaching said cover to said container;
at least one mounting bracket secured to the back wall of the container;
wherein the container is adapted for removably mounting to a livestock fence by sliding said at least one mounting bracket onto a top rail of the livestock fence, so that animal feed can be loaded into said container by pivoting the cover to an open position and inserting animal feed through the open top into the container.

14. The animal feeder according to claim 13, wherein the bottom wall of said container is sloped downward from the back wall to the front wall, whereby animal feed loaded in said container slides toward the at least one opening in the front wall.

15. The animal feeder according to claim 13, wherein said container is constructed of a material from the group consisting of plastic, metal and rubber.

16. The animal feeder according to claim 13, further comprising at least one upper padlock flange extending from said cover, and at least one lower padlock flange extending from said container, each of the upper and lower padlock flanges having an aperture adapted to receive an arm member of a padlock.

17. The animal feeder according to claim 13, wherein said at least one hinge knuckle on said container further includes a first set of hinge knuckles attached to said back wall and, a second set of hinge knuckles attached to the front wall; and said at least one hinge knuckle on said cover further includes an opposing first set of hinge knuckles on a front edge of the cover, an opposing second set of hinge knuckles on a back edge of the cover; and
said at least one removable hinge pin for selectively connecting said first set of hinge knuckles to said first set of opposing hinge knuckles, and said second set of hinge knuckles with said second set of opposing hinge knuckles;
whereby said cover optionally pivots on said back wall or said front wall by placement of said hinge pin through said first or second set of knuckles, respectively.

18. The animal feeder according to claim 13, further comprising a side dish extending from one of said two sidewalls of said container.

19. The animal feeder according to claim 13, wherein said at least one mounting bracket is constructed of a material from the group consisting of plastic and metal.

20. The animal feeder according to claim 13, wherein said container is dimensioned and configured to receive a bale of hay.

21. The animal feeder according to claim 13, wherein said at least one opening comprises three openings in the front wall, each of said openings having a width of about seven inches.
